(19) United States
(12) Patent Application Publication
(10) Pub. No.: US 2015/0222526 A1
(43) Pub. Date: Aug. 6, 2015

(54) NETWORK AND SERVICE LAYERS FOR NEXT GENERATION ACCESS NETWORKS

(71) Applicant: Calix, Inc., Petaluma, CA (US)

(72) Inventor: Berkay Baykal, Westborough, MA (US)

(73) Assignee: Calix, Inc., Petaluma, CA (US)

(21) Appl. No.: 14/272,860

(22) Filed: May 8, 2014

Related U.S. Application Data
(60) Provisional application No. 61/936,039, filed on Feb. 5, 2014.

(51) Int. Cl. H04L 12/725; H04L 12/741

(52) U.S. Cl. CPC H04L 45/308; H04L 45/74

(57) ABSTRACT

Network and service layers for next generation access networks are provided. In one embodiment, a method for providing network services within an access network is provided. The method comprises: receiving one or more user packets of a user packet flow at a first node located within an access network, wherein the access network comprises a plurality of service nodes each hosting at least one network service application; defining subscriber policy requirements associated with the user packet flow by inspecting at least a first user packet of the user packet flow at the first node; and encapsulating the one or more user packets within an access network routing packet, the access network routing packet including application server addressing that routes the user packet flow to at least a first service node of the plurality of service nodes based on the subscriber policy requirements.

### CROSS-REFERENCE TO RELATED APPLICATIONS

This application claims priority to, and the benefit of, U.S. Provisional Application No. 61/936,039 entitled “NETWORK AND SERVICE LAYERS FOR NEXT GENERATION ACCESS NETWORKS” (Attorney Docket 180.014USPR) filed on Feb. 5, 2014, which is incorporated herein by reference in its entirety.

### BACKGROUND

Communications service providers (CSP) are planning to provide an increasing number of services beyond the traditional voice, video and internet access services. The access networks built for providing only triple play services (that is, telephone, television and broadband internet) are not sufficient in an environment where a CSP plans to offer multitude of service using a high pace innovation cycle. Networks today are built are around Layer 2 (data link layer) and Layer 3 (network layer) addressing schemes where a subscriber device (CPE) connects to a network device to get service. Packets flow based on the layer 2 and layer 3 addresses, contained in every packet, which are resolved (determined) through well-known protocols such as DHCP, DNS, ARP and etc. Layer 2 Bridging tables and Layer 3 forwarding tables are used to switch/route packets between the user, originator, and an end point. However, as the services needs and expectations of end-users evolve, directing packet flows using these addressing schemes is reaching its limits.

Communication Service Providers (CSPs) are interested in improving their service offerings beyond the traditional triple play services (voice, video and internet access). Services that are commonly being added to the mix include, but are not limited to, home control and security, information technology (IT) services for home networks and devices, and remote access to home networks. A CSP can handle the fluidity of new services by using different demarcation device to serve each customer profile. That is, a customer who wants none of these services received one demarcation device versus the customer who want one or more who receives a difference demarcation device. Alternatively the CSP can deliver a device that is capable of delivering all these services and configure the device based on subscriber preferences. However both these models quickly breaks down in an environment where the CSP expects service mixes as well as the services themselves to change at a high pace.

For the reasons stated above and for other reasons stated below which will become apparent to those skilled in the art upon reading and understanding the specification, there is a need in the art for improved systems and methods for network and service layers for next generation access networks.

### DRAWINGS

Embodiments of the present invention can be more easily understood and further advantages and uses thereof more readily apparent, when considered in view of the description of the preferred embodiments and the following figures in which:

FIGS. 1 and 1A are diagrams illustrating a network of one embodiment of the present disclosure; a

FIG. 2 is a diagram illustrating a packet encapsulation of one embodiment of the present disclosure;

FIGS. 3 and 3A are diagrams illustrating a network of one embodiment of the present disclosure;

FIG. 4 is a diagram illustrating a network of one embodiment of the present disclosure; and

FIG. 5 is a flow chart illustrating a method of one embodiment of the present disclosure.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present disclosure address the needs of these new service operators by providing a network service layer which fosters an environment for high pace service innovation without necessarily requiring the operator to modify the network with the addition of each and every new service.

Embodiments of the present invention provide a framework for deploying new services using one or more application servers deployed within the access infrastructure of a network, also referred to herein as the access network. With embodiments of the present disclosure, the access infrastructure directs packet traffic towards these application servers based on the service profile of a given subscriber and/or end user. As described by the various embodiments below, this is achieved in a network agnostic way where each original user packet generated by an end user are, for example, is embedded within in a new layer 2 or layer 3 packet referred to herein as an access network routing packet. This access network routing packet comprises a structure which is utilized by the access infrastructure to determine the path that the original packet should take within the access infrastructure. That is, the access network routing packets include a sequence which describes of all the services within the access infrastructure that a given packet flow is exposed to, before the original user packet is permitted to proceed beyond the access infrastructure. Further, embodiments presented in this disclosure address packet flows flowing back to the user, defining the path that an inbound packet should take within the access infrastructure including the sequence of all the services within the access network that the inbound packet flow should be exposed to before proceeding to the subscriber's local network.

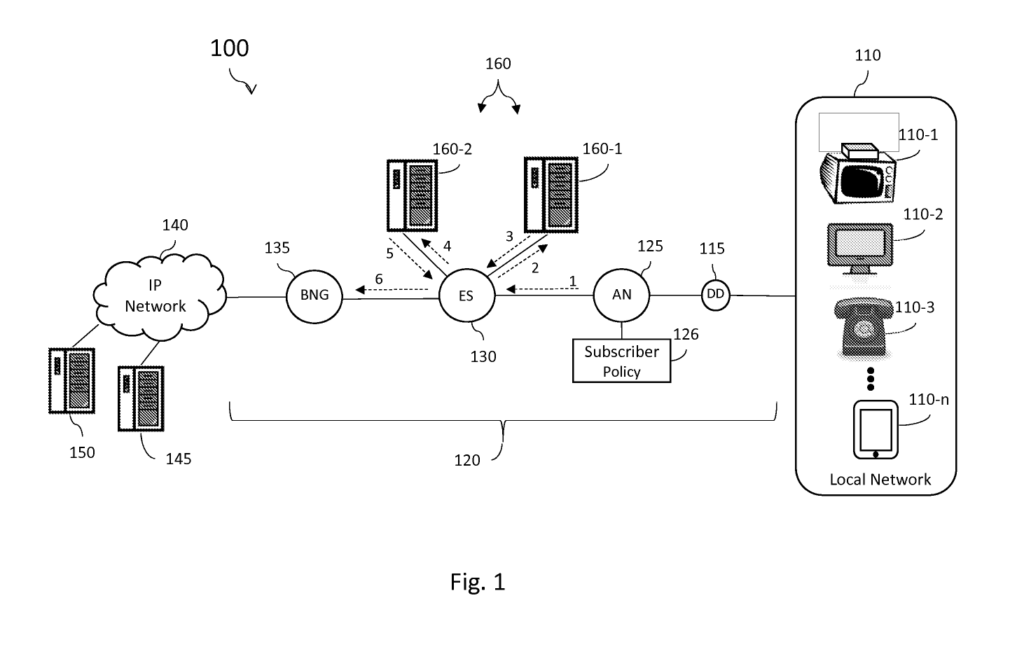

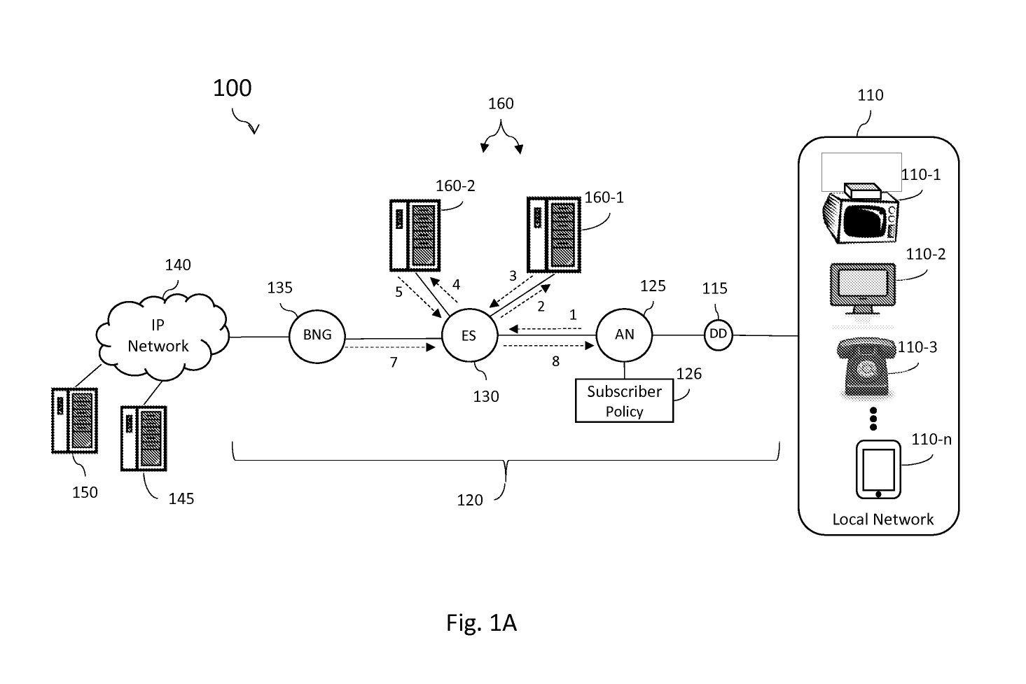

FIG. 1 is a diagram illustrating a network 100 of one embodiment of the present disclosure. Network 100 comprises a local subscriber network 110 (referred to herein at local network 110) coupled to an access infrastructure referred to herein as access network 120. As the term is used herein, an “access network” such as access network 120, refers to an access infrastructure that communicatively couples the local network 110 to an Internet Protocol (IP) Network 140, which in some embodiments comprises the Internet. One or more content application servers shown at 150-1 and 150-2, and referred to collectively as content application servers 150, are external to the access network 120 but accessible via the IP Network 140. Content application servers 150 provide users of the local network 110 with a variety of services. Example services which may be provided by content application servers 150 include, but are not limited to, television programming, email, Voice over IP (VoIP) telephone, video-on-demand services (such as but not limited to “Netflix”), social media services (such as, but not limited to “Facebook” and “Twitter”), and the like. IP Network 140 may comprise a closed-access proprietary network, an open-access network (such as the Internet), or some combination of such networks. In one embodiment, access network 120 operates as what is referred to by those familiar with network architecture design as an Open Systems interconnection model (OSI) Layer 2 data link layer network. In other embodiments, it may operate using OSI Layer 3.

Access network 120 further comprises at least one demarcation device 115 that defines an interface between the local network 110 and the access network 120. Access network 120 further comprises an Access Node (AN) 125, one or more switches 130 (which may comprise Ethernet switches (ES)) and a Broadband Network Gateway 135 (BNG), which interfaces the access network 120 with the IP Network 140. Further coupled to access network 120 via switch 130 are one or more service nodes 160-1 and 160-2, which are referred to collectively as service nodes 160 and discussed below. More specifically, as the term is used herein, service nodes 160 refer to application servers within access network 120 that host network services, as discussed below.

The local network 110, which works in conjunction with the access network 120, comprises a plurality of end-user access devices shown at 110-1 to 110-n. In some embodiments, each of the access devices 110-1 to 110-n and local network 110 itself are associated with a single “subscriber” that subscribes to the services offered by the content services provided (CSP). Local network 110 can be a complex network in its own right where multiple network technologies (Ethernet over Cat5, Coax or Power and Wi-Fi), devices with different capabilities (light switch, garage door opener, smart meters, laptops, TV sets, set-top-boxes, wire-line and wireless phones, cameras, security systems) and users with different access privileges exist. The particular local network 110 shown in FIG. 1 illustrates a set-top box (or network enabled television) 110-1, a computer 110-2 (which may comprise, for example, a desktop or laptop computer), a voice-over-internet (VoIP) telephone device 110-3, and at least one other device 110-n which may include, but is not limited to a tablet, smart-phone, or other smart-appliance.

Any one of the end-user access devices shown 110-1 to 110-n (such as computer 110-2, for example) can be used by either adult or a non-adult users and each of the potential users will have different service expectations. Further, the term “local network” is not intended to necessarily refer only to residential premises, subscribers or users. That is, in addition to residential and consumer implementations, local network 110 may comprise a small business or an industrial, enterprise or other commercial implementation which may be centrally located or comprise a network distributed across a large geographic area.

The access network 120 and the local network 110 interface through a demarcation device 115. In alternate implementations, demarcation device 115 can comprise devices such as, but not limited to, an Optical Network Terminal (ONT), a Very-high-bit-rate digital subscriber line (VDSL)/Asymmetric digital subscriber line (ADSL) modem, or a wireless endpoint (such as a Long Term Evolution (LTE) or Global System for Mobile Communications (GSM) endpoint) depending on the infrastructure of the service provider. The demarcation device 115 may also be realized as a simple layer 2 bridge or a layer 3 gateway (sometimes referred to as residential gateway). In some embodiments, demarcation device 115 is implemented as a logical function such that the role of the demarcation device 115 can be distributed between the access node 125 and demarcation device 115 or even pulled further into the access network 120 and implemented within other network elements.

Demarcation device 115, as its name implies, marks the end of the operator's network (i.e., access network 120) and the beginning of the subscriber's local network 110. This line of responsibility can sometimes be a complicated issue with services such as Pay TV which often require the network operator to deploy one or more set-top boxes through the house (such as set-top box 110-1). Other examples where operator devices may be deployed on the local network 110 side of demarcation device 115 include devices providing security services or wireless data coverage. In these cases, the operator continues to own the responsibility to maintain these devices although technically they reside in the local network 110 which is not directly the responsibility of the operator.

The access node 125, as will be described in greater detail below, is the first network equipment that is deployed in a location that is in complete control of the access network 120 operator. Access node 125 can be deployed outside in a cabinet, on a pole or in an environmentally controlled central office. In some embodiments, switches 130 may comprise switching devices such as Ethernet switches. These switches 130 will function to aggregate traffic from multiple Access Nodes within access network 120 as well as well as direct traffic to and from service nodes 160-1 and 160-2 as detailed below.

In the embodiment shown in FIGS. 1 and 1A, BNG 135 comprises a router and functions as a termination point for access network 120. BNG 135 may also store and maintain subscriber and service provisioning information and cooperates with the access node 125 and/or the demarcation device 115 to realize access to the IP Network 140 connected content application servers 150 which are offered to the users of local network 110. Beyond the BNG 135, the various content application servers 150 are deployed to realize one or more content services directly offered by the CSP or other entity and may also provide functions to maintain the access network 120 infrastructure—such as Dynamic Host Configuration Protocol (DHCP) and Domain Name System (DNS) servers. An operator may also deploy amongst content application servers 150 applications that aid in assessing Quality of Service, comply with regulatory requirements such as CALEA, collect performance metrics or network policy management applications.

For some implementation, demarcation device 115 functions an IP gateway and provides complete network isolation between the local network 110 and IP Network 140 by using private IP addresses to the local devices (110-1 to 110-n) and translating the private IP addresses to a public IP address using, for example, network address translation (NAT). When one of the local network 110 devices (110-1 to 110-n) needs to access a network service, such as a Pay TV service available through Application Server 150-2 for example, it locates the service by using network protocols such as DNS and Address Resolution Protocol (ARP) and attempts to contact server 150-2 by using its layer 3 address. Packets belonging to the service are switched through the layer 2 section of the network 120 (using the layer 2 identity of the first hop router) and routed beyond the BNG 135 towards the Pay TV service's server 150-2.

Network service nodes 160 represent servers for other applications that can be offered to subscribers as a service by the CSP from within access network 120. As an example, parental control as a service is highly desirable to parents who are interested in providing their children access to the internet but at the same time ensure that they can only access age appropriate content. When this service is offered by a service provider, the service provider needs to know the user profile associated with every service flow and only provide parental control service to users who have selected this service. To provide this service, the CSP connects a network service node 160 (such as network service node 160-2, for example) to access network 120 as an application server that provides parental control services. As such, only packet flows subject to parental controls need to go through network service node 160-2.

Network security is another example of a service which can be offered by a CSP. The CSP similarly connect a network service node 160 (such as network service node 160-2, for example) to access network 120 as an application server that provides network security services. In this case, network service node 160-1 may need to have visibility to all packet flow traffic so that it can analyze the traffic flow for traffic patterns, virus and malware signatures. In still other embodiments, additional services can be offered through network services nodes 160 coupled to the access network 120. In some implementations, each such service can reside on its own network service node 160 on access network 120. Alternately, in some implementations, one network service node 160 may function as an application server for multiple services.

Network security and parental control are two examples of services that are not necessarily “addressable” services. It would also be considered good practice for the subscriber to provide their consent to the service provider so that the CSP can intercept and treat subscriber traffic as needed. Clearly not all subscribers will sign up for all services and over time the subscription profile of a given subscriber can change. For example, a subscriber who did not initially subscribe to the network security feature may subsequently subscribe to it or, a subscriber who took both network security and parental control services can drop one.

In the embodiment shown in FIG. 1, access to the services provided by network service nodes 160 is provided through the management of user packet flows by access node 125. Access node 125 provides both a convenient and efficient point within access network 120 to both gather the information needed for network service nodes 160 and route that information to service nodes 160 based on policies associated with the subscriber for hone network 110. This is at least in part because the access node 125 is the closest network device (prior to demarcating device 115) in access network 120 to the subscriber's local network 110 and has the ability to obtain information other component in access network 120 cannot as easily obtain. Access node 125 also is traditionally the touch point for passing on the configuration information in terms of services offered to a subscriber. In some embodiments, the functions described herein of the access node 125 and the demarcation device 115 are integrated into a single device. In still other embodiments, the access node 125 and the demarcation device 115 are distinct and separate network devices, but the functions described herein with respect to access node 125 are instead performed by the combination of the access node 125 and the demarcation device 115, these two components cooperating such that one or more of the access node 125 functions are performed at least in part by the demarcation device 115.

With embodiments of the present disclosure, access node 125 is enhanced to have application awareness on top of the functions typically provided by an access node. More specifically, access node 125 performs deep packet inspection of the traffic flowing from and into local network 110. By performing deep packet inspection access node 125 is able to detect an interaction associated with a user packet and identify that packet as part of a certain user packet flow. For example, in one implementation, access node 125 learns from deep packet inspection the ultimate destination address of a user packet. Access node 125 can then look up that destination address via a table or other resource, and identify that user packet as involving an interaction with a particular application server 150 beyond access network 120. Based on this information, access node 125 can also associate that user packet, and the user packet flow of which it is a part, with a certain content provider or service. Alternatively, in other implementations, access node 125 can look deeper into the user packet and identify an application service protocol being used or other signature such as a packet structure within the user packet which reveals the application services being accessed from application servers 150. In one embodiment, this dissection can be performed on the first few user packets of a user packet flow until the access node 125 makes a determination on the purpose of the user packet flow (for example, email messages, Netflix transactions, Facebook account access, etc.). Access node 125 can then associate subsequent user packages of that user packet flow with the identified application service based on that determination.

In one embodiment, in operation, access node 125 receives an outbound packet from the local network 110. These packets originating from devices on local network 110 are referred to herein as “original user packets”, or just “user packets”. The user packet's header will indicate the intended destination address for the user packet as well as which of the end-user devices 110-1 to 110-n originated the user packet. As discussed above, by looking within the user packet, the access node 125 can determine an application server 150 to associate with the packet and accordingly the type of interaction the end-user is attempting to initiate. For example, based on a deep packet inspection, the access node 125 may determine that the user packet if part of a user packet flow attempting to perform a Facebook interaction, or a Netflix interaction. The access node 125, based on these inspects learns that certain packet flows are associated with certain applications and not others. When the access node 125 establishes information such as which application and application server 150 a packet flow is associated with, which internal user within local network 110 the user packet is coming from, which device 110-1 to 110-n within local network 110 is being used to generate the user packet, access node 125 can then enforce a set of policies, (referred to herein as subscriber policy requirements), established by a subscriber with the CSP.

Using this information, the access node 125 establishes a path through the access network 120 that the user packet, and the relevant information collected by access node 125, will take. For example, if the local network 110's subscriber has subscribed only to the parental control service, then access node 125 will look at the subscriber policy 126 to determine which user packets should be directed to the service node 160 within access network 120 that implements the parental control service. As discussed above, families with children may want to be able to enforce policies on how different members of the household can leverage the Internet. They may want to have a policy that restricts their younger children from accessing on-demand movie content rated for mature audiences or adults. The CSP implements the parental control application to provide this service in a service node 160 (such as service node 160-2, for example) in conjunction with the information gathering and routing functions provided by access node 125. For example, when the user packet is determined to originate from an adult user where, per information stored in subscriber policy 126, no parental controls apply, then Access Node 125 can pass the user packet flow associated with that user packet directly to the BNG 135. That is, the user packet flow is routed out of access network 120 in a standard manner without further inspection or modification of that packet flow. This is illustrated in FIG. 1 as following path 1 to path 6.

If a user packet instead originates from a user where, per information stored in subscriber policy 126, parental controls do apply, then the user packet flow associated with that user packet is routed through service node 160-2 where a parental control application is applied to the packet flow. If the interaction is permissible per a parental control policy associated with the user, the original user packet and the user packet flow associated with that packet is permitted to pass to the BNG 135 to the destination address indicated in the original user packet. This is illustrated in FIG. 1 as following path 1 to path 4 to path 5 to path 6. In one embodiment, if the interaction is not permissible per the parental control policy, the parental control application at service node 160-2 returns a message to access node 125 that the interaction has been blocked per the parental control policy, which may be presented back to the end-user.

As another example, in another implementation the subscriber associated with local network 110 has elected to receive network security services in addition to parental control services. In this example, access node 125 will need to provide a path for all user packet flows to be sent to the network security application hosted at service node 160-1, and those user packet flows where the parental control policy applies will also be sent to the parental control application hosted at service node 160-2. That is, if the user packet originates from an adult user where no parental controls apply, the access node 125 can pass the user packet flow associated with that user packet directly to the network security application at service node 160-1 and if the interaction is permissible per the network security policy, the user packet flow is directed to the destination address indicated in the original user packet (i.e., one of the content application servers 150). This is illustrated in FIG. 1 as following path 1 to path 2 to path 3 to path 6.

If the user packet instead originates from a user where parental controls do apply, then packet is directed through both the network security application at service node 160-1 and the parental control application at service node 160-2 before being permitted to travel to the destination address indicated in the original user packet. For example, in one embodiment, after processing the user packet, the network security application at service node 160-1 will route the user packet flow associated with that packet user packet on to service node 160-2. If the interaction is permissible per the parental control policy, the original user packet and the user packet flow associated with that user packet is permitted to pass to the BNG 135 to the destination address indicated in the original packet to one of the content application servers 150. This is illustrated in FIG. 1 as following path 1 to path 2 to path 3 to path 4 to path 5 to path 6.

By directing the user packet flow through a path of prescribed service nodes 160 within access network 120, access node 125 can tailor different paths for different packet flows. The particular path applied to a user packet flow is determined from both the subscriber policies and characteristics of the user packet flow identified by access node 125. When the CSP introduces new services, access node 125 merely needs to be updated to know which service node 160 in access network 120 hosts the application that provides that new service. Access node 125 can then create a path to apply the new service to the appropriate user packet flow in accordance to the subscriber preferences set forth in the subscriber policy 126.

At the same time, there may be operator policies associated with these applications that the CSP operator, rather than the subscriber, would like to enforce. In that case, although the operator policies may be stored within subscriber policy 126, the subscriber would not have the option to opt-out of those policies. For example, in one implementation a CSP has a network policy meters or limits a subscriber's usage of an application provided by one of application servers 150. These limits may be implemented by an application at one of service nodes 160 that enforce this network polity. In the same manner as describe above, once access node 125 identifies that a user packet flow is associated with an application that is metered per network policy, access node 125 includes the service nodes 160 implementing that network policy in the path through which the user packet flow is directed.

As mentioned above, in addition to identifying which application services are being accessed from application servers 150 by a user, access node 125 may need to further identify which user within local network 110 is associated with a given user packet flow. This can be achieved in various ways.

In one embodiment, users connecting to access network 120 will utilize a CSP provided application interface to associate the devices (110-1 to 110-n) within local network 110 with specific users. For example, a first tablet computer within local network 110 may be assigned to first user who is identified via the application interface as an adult. Meanwhile, a second tablet is assigned to a second user which identified as child. In the same way, an Internet enabled game console is associate with another child user while an Internet enabled “smart” television is associated with another adult user. This model provides a one-to-one correspondence between devices and users. Other internet connected devices may comprise smart appliances (such as smart thermostats, refrigerators, etc.) which can be assigned to fictional virtual users, rather than real human users. When a user packed is received by access node 125 from a device, it presumes that the user assigned to that device is actually using the device and enforces the subscriber policies 126 accordingly.

On the other hand, local network 110 may include shared devices, such as a family desktop computer, which is utilized by multiple users. In that case, adult users of shared devices may not wish to have their interactions limited with the same restrictions associated with their children. Accordingly, in one embodiment, the CSP may implement an authentication service accessible through access network 120 that authenticates which users are operating devices 110-1 dynamically. The authentication service would present the user at a device with a logon screen requiring the user to enter credentials such as, but not necessarily limited to, a username and password. The access node 125 would recognized the exchange of user packets as a user packet flow associated with the authentication service and extract the username or otherwise glean the identity of the user operating the device. Access node 125 would then define a one-to-one correspondence between that device and the user identified from the authentication service packet exchange. Future user packets from that device would then be directed on a path through service nodes 160 as appropriate for that user based on the subscriber policy 126. By observing the authentication traffic between the user and the authentication application, access node 125 can understand which user is currently using a given device 110-1 to 110-n at any given time and then apply the appropriate policy to adjust packet flows for that user and device accordingly.

For inbound user packets received by access network 120 from IP network 140, access node 125 may function in a similar manner to route the user packet through a path of one or more service nodes 160 prior to forwarding the inbound user packet to a device 110-1 to 110-n within local network 110.

For example, in one embodiment, switch 130 can learn the path applied to an outbound user packet flows associated with certain application hosted by application servers 150. When a corresponding incoming user packet is received, the switch 130 forwards the incoming user packet flow through the same path of service nodes 160 applied to the outbound user packet flow, but in the reverse order.

In another embodiment, since the access node 125 is already familiar with how to route outbound user packet flows through access network 120 based on policies, it can route inbound user packet flows in the same manner. For example, in one embodiment, an inbound packet flow received from IP network 140 at BNG 135 would be routed directly to access node 125. That is, it would follow path 7 to path 8 as shown in FIG. 1A. Access node 125 would then associate the inbound user packet flow with a corresponding outbound user packet flow and route it through the same path of service nodes 160 that was applied to the outbound user packet flow. For example, if an outbound user packet from a non-adult user is routed through server node 160-2 for patent control, then an incoming user packet received in response to that outbound user packet would also be routed through the parental control application at server node 160-2 before being forward by access node 125 to the intended device 110-1 to 110-n. That is, where the outbound user packet flow followed path 1 to path 4 to path 5 to path 6 (in FIG. 1), the inbound user packet flow would be directed to follow path 7 to path 8 to path 1 to path 4 to path 5 to path 8 (in FIG. 1A) so that the parental control application at service node 160-2 is applied to the inbound traffic before being sent on to the intended device 110-1 to 110-n that requested the content. Similarly, access node 125 may send all incoming user packet flows through a network security application at service node 160-1 to scan for incoming malware before sending them to their intended device 110-1 to 110-n.

In one embodiment, access node 125 may perform a deep packet inspection of incoming packets to identify an associated application and intended interaction type. In some embodiments, the Access Node 125 can learn what kind of incoming application packets are being received and correlate that information with subscriber, device and user information kept from associated outbound packet flows and make sure that the incoming packets follow the same logic applied to the outgoing packets.

As mentioned above, in addition to identifying a user within the local network with a given user packet flow, service nodes 160 may need still additional information depending on the service they are to perform. For example, a service node 160 may need to be provided subscriber, device, user and application information in addition to possibly the origination and destination addresses of the original user data packet. In addition, a service node 160 may need to know about other service nodes 160 included in the packet flow path prescribed by access node 125. Embodiments of the present disclosure address these needs through packet encapsulation.

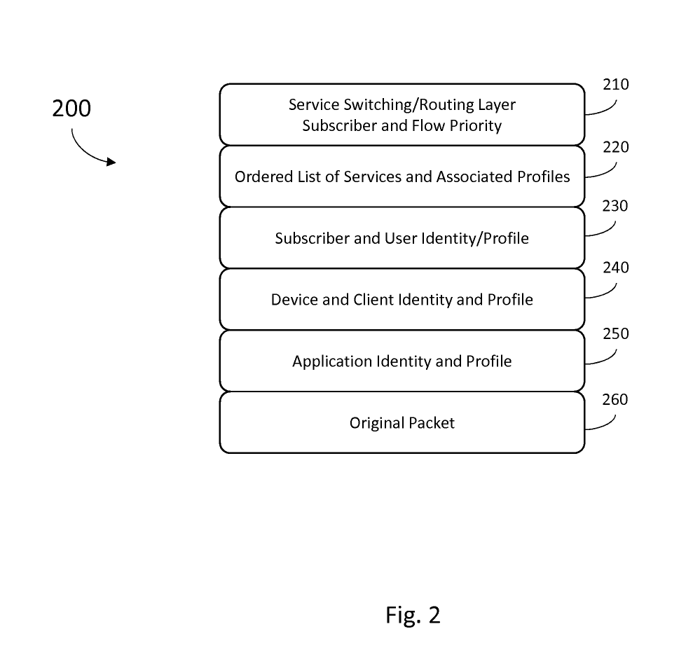

FIG. 2 is a diagram illustrating an access network routing packet encapsulation structure 200 for an encapsulating packet 205 of one such embodiment of the present disclosure. In the embodiment shown in FIG. 2, the access node 125 encapsulates the original user packets received from device 110-1 to 110-n within a new access network routing packet having packet encapsulation structure 200 as described below. It should be appreciated that not every access network routing packet 205 needs to include every section described below, that the packet sections included in an access network routing packet 205 may vary based on the network and subscriber policies being applied to a user packet, and the information needed to carry out those policies.

Section 210 of access network routing packet 205 comprises a new packet header that includes Application Server Addressing which enables the access network 120 to direct packets to a first of the service nodes 160 where a first application service is applied. This Application Server Addressing may be implemented using an overlay method where an Application Identifier (Application ID) for the application service is converted to MAC, IP or MAC+IP Addresses to direct packets to the appropriate one of the service nodes 160. Alternatively, the Application ID itself may be included in the packet header of section 120 and natively used to direct packets. The packet header in section 210 may also include subscriber and flow priority information. These two items of information together determine the Quality of Service treatment associated with the encapsulating access network routing packet 205. As an example a “gold level” subscriber might have their packets 205 provided with a better level of service within access network 120 than a bronze level subscriber who is attempting to access the exact same services from servers 150. Each service also gets a relative priority against other services.

Section 220 of access network routing packet 205, in one embodiment, comprises an ordered list of services that the access network routing packet 205 is going to be subjected to within access network 120. For example, where access network routing packet 205 is to be exposed to three different application service, the ordered list of services may include the Application Server Addressing for each of those services in the order in which they should be applied. Alternately, where section 210 includes the Application Server Addressing for a first service, section 210 may include an ordered list of services with the Application Server Addressing for services that are to be applied after the first service. In other words, using the ordered list of services in section 220, access node 125 encodes within packet 205 the path through access network 120 that a user packets for a particular user packet flow will follow.

For example, in one implementation, section 220 may indicate that access network routing packet 205 is to be first routed to service node 160-1 and then to service node 160-2. In one embodiment, when the application service hosted as service node 160-1 is completed, the Application Server Addressing for service node 160-1 is striped from section 210 and replaced by the Application Server Addressing for the next service indicated in the ordered list of services. As such, ordered list of services includes the appropriate Application Server Addressing for one or more “next” nodes that the packet 205 is passed to after being processed by the node indicated by the Application Server Address provided in Section 210. In one embodiment, once all access network service indicated in section 220 have been performed, packet 205 may be stripped down to the original user packet (contained in section 260 as described below) and permitted to proceed to the application server 150 or device 110-1 to 110-n indicated by the destination address in its original header.

Section 230 of access network routing packet 205 comprises information which identifies one or both of the CSP subscriber that own local network 110 and the identity of the user at the device 110-1 to 110-n that is associated with the user packet. That is, the subscriber and user information may be used by service node 160 to associate a user packet flow with a specific user for a specific client. For example, a subscriber's account may include two non-adults of different ages. Although the subscriber wants parental control services is applied to both, a stricter level of parental control services is applied to be applied to the younger child than the older child. The subscriber and user information provides service node 160 with the information needed to apply the appropriate level of parental control services to the user packet flow.

Section 240 of access network routing packet 205 comprises information which identifies device and client application identity information. For example, device information would be used by service node 160 to determine what type of device is being used to generate the user packet flow. For example, the device information may identify the device as being a set-top-box, a game system, a television, a desktop or laptop, or a mobile device such as a tablet or phone, or an internet capable appliance such as a thermostat. The client application refers to the client software application being used on the device. For example, to access a website, a user may use a client application such as Apple's Safari or Google's Chrome web browsers. To access streamed video content, such as from Netflix, the user may use a general purpose client such as a web browser, or a dedicated client application. As an example, Section 240 may indicate that the original user packet was generated by an Apple iPad using the Safari web browser.

Section 250 of access network routing packet 205 provides the Application Identity of the internet application or service at application servers 150 that the packet user flow is interacting with. For example, the Application Identity may identify the packet user flow as being a social-medium interaction (e.g., a “Facebook” interaction), a streaming media interaction (e.g. a video or Internet radio streaming service), or an interaction with any one of a myriad of services available from application servers 150. Section 260 of packet 205 comprises the original user packet as sent by the end-user device 110-1 to 110-n (for an outgoing user packet) or as received from IP Network 140 (for an incoming user packet).

As mentioned above, it should be appreciated that not every access network routing packet 205 needs to include every section described in FIG. 2, and that the packet sections included in an access network routing packet 205 may vary based on the network and subscriber policies being applied to a user packet, and the information needed to carry out those policies. Further, in other embodiments, the information described as being conveyed by these packet sections does not need to be organized into the specific format shown in FIG. 2. That is, regardless of how this information is conveyed, each application at the service nodes 160 receiving the encapsulated packet 205 will utilize the contextual information it needs from the encapsulated packet 205 to provide its service. The service node 160 may then modify the access network routing packet 205 as described above to direct it to its next destination. Further, an application service hosted by a service node 160 can modify the proposed path through access network 120 that was established by access node 125 if or when needed. For example, if a network security service application or parental control service application hosted by a service node 160 deems that a user packet flow should be blocked, then the access network routing packet 205 can be modified by that service application to re-direct a user packet to the access node 125, with an indication that the requested interaction is not authorized. Access node 125 can then generate an appropriate notification back to the originating device that the interaction was blocked per network or subscriber policy. Further, if a network security application determines that a user packet flow is a potential security risk, it may modify access network routing packet 205 to direct the user packet flow towards a recording/analysis function for further processing instead of or in addition to sending it to its next destination.

The information about the user packet flow that is populated within the access network routing packet 205 may come from various sources including but not limited to: provisioned information, discovered information and dynamic information. Provisioned information is information obtained by access node 125 from a CSP's back-office server (for example, service, service level, subscriber and user information). Provisioned information that is available at the CSP back-office and can be communicated to access node 125 as part of a service provisioning procedure, or alternately access node 125 can access this information via an authentication protocol used by the user.

Discovered information may include device type information, client application information, application identity and possibly user information determined, for example, through deep packet inspection of user packets; and dynamic information such as subscriber or user usage statistics. In some embodiments, a combination of provisioned and discovered information is utilized. For example, the devices 110-1 to 110-n connected through local network 110 might be discovered by access node 125, but the subscriber is expected to associate the devices with specific users and user profiles as part of the service provisioning procedure.

With respect to dynamic information, one example is flow priority which can be dynamically determined from both provisioned information and utilization information. As an example, if a subscriber reaches a monthly usage limit, their services may be downgraded in terms of priority for the remainder of the month. Other services may require knowledge of the device class and capabilities of the end user device 110-1 to 110-n, which can be easily identified by the access node 125. An example of such a service could be a video on demand service where the content requests are directed to a different class of application server 150 based on the capabilities of the end user device 110-1 to 110-n.

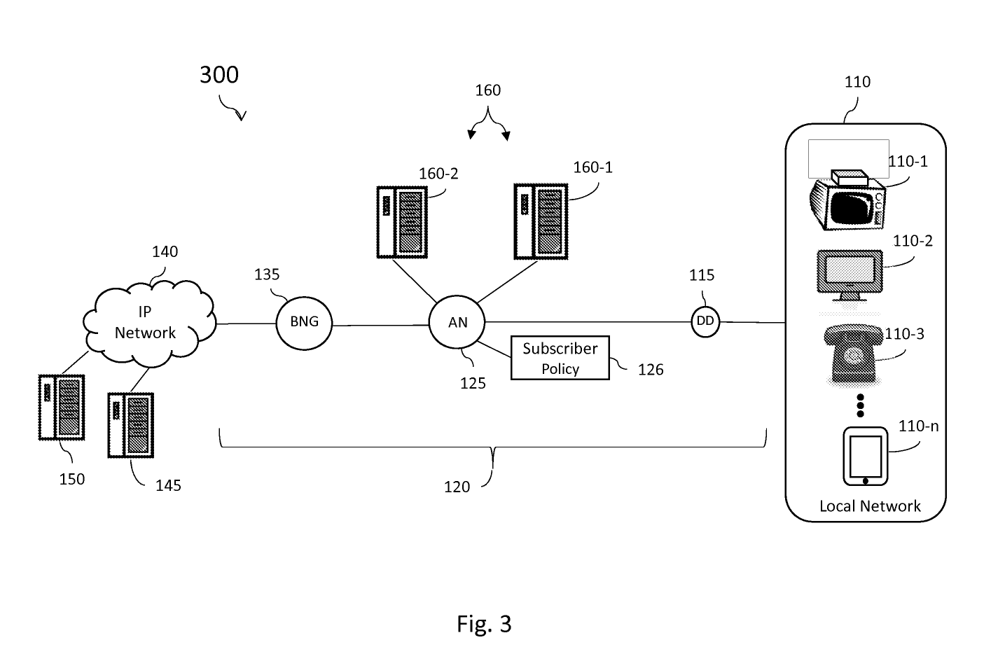

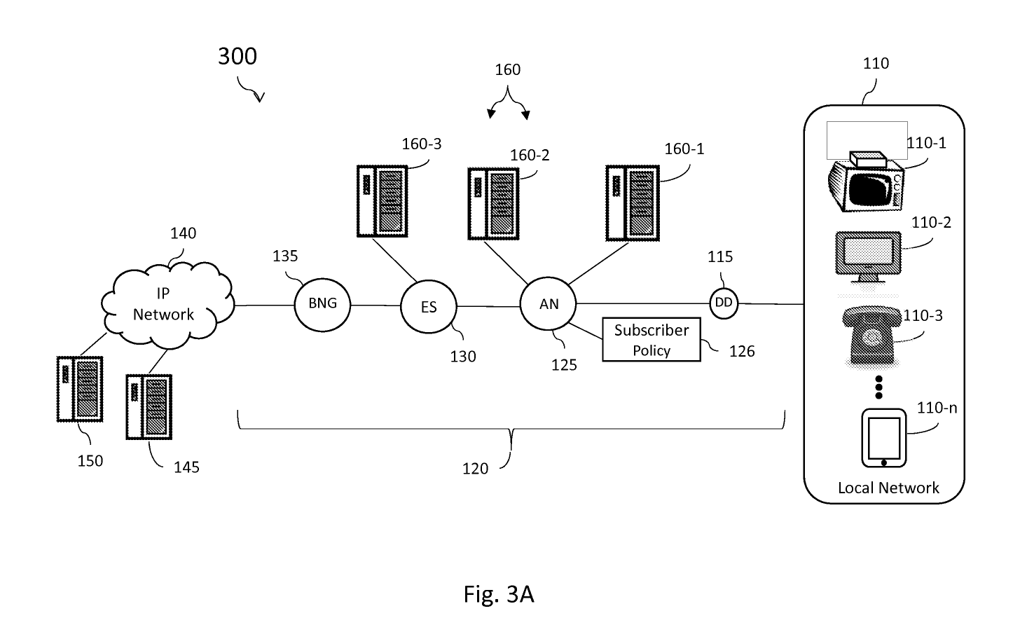

FIG. 3 is a diagram illustrating a network 300 of one embodiment of the present disclosure. Network 300 comprises the same elements performing the same functions as described with respect to network 100 except that one or more of the service nodes 160 (and the application services they provide) are subtended directly from access node 125 rather than a switch 130. For example, in one embodiment, the switching functionality of switch 130 is integrated into access node 125. In one alternate embodiment, shown in FIG. 3A, the structure of networks 100 and 300 are combined so that some service nodes 160 are coupled to access network 120 through access node 125 while others are coupled to access network 120 through a switch 130.

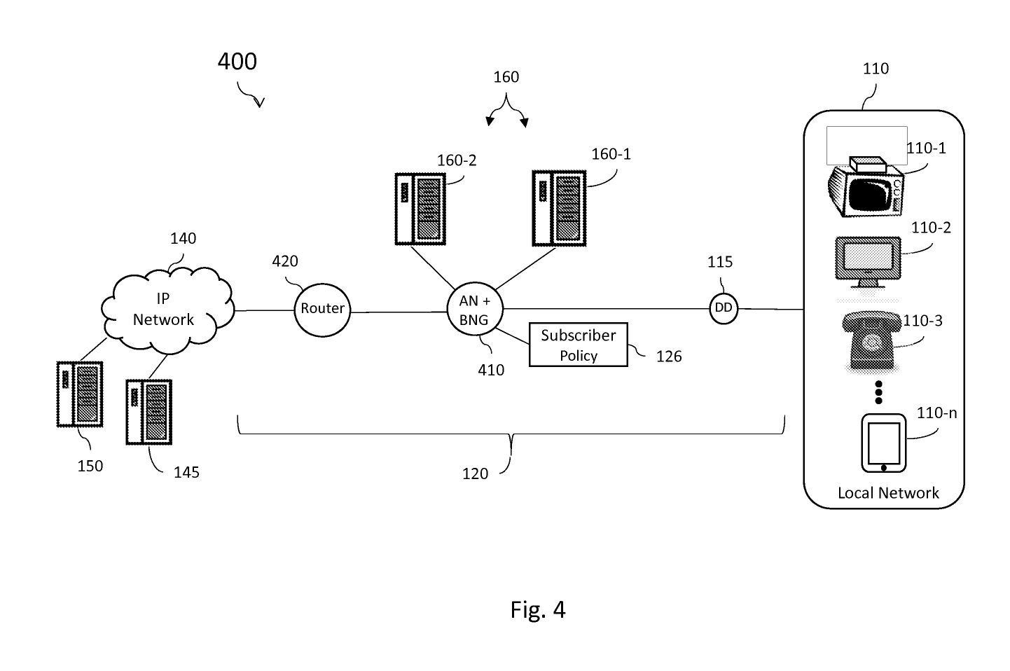

FIG. 4 is a diagram illustration a network 400 of still another embodiment of the present disclosure. Network 400 comprises the same elements performing the same functions as described with respect to networks 100 and 300 except that the functionality of BNG 135 and access node 125 are integrated into a single device (shown as 410) and access network 120 is coupled to IP network 140 (and thus application servers 150) via a router 420. One or more of the service nodes 160 (and the application services they provide) are subtended from the combined BNG/Access Node 410. In yet another alternate embodiment, the structure of networks 100 and 400 are combined so that some service nodes 160 are coupled to access network 120 through the combined BNG/Access Node 410 while others are coupled to access network 120 through a switch.

With the proposed methodology presented herein, the access network 120 does not require an “orchestration level” to setup the path through the access network 120 for a service flow. Instead, the network is self-sufficient and expected to work independently as an IP network would. The proposed methodology uses a single point in the network where dynamic and provisioned information is accumulated and applied to the user packet flows which is a well-suited architecture model where this information needs to be distributed to multiple endpoints in the network. Service applications provided by service nodes 160 are insulated from the IP network 140 and the subscriber, user and service provisioning layers of access network 120. New applications services can be added to service nodes 160 and existing ones can be easily modified without impact to other application services or the switching/routing layer.

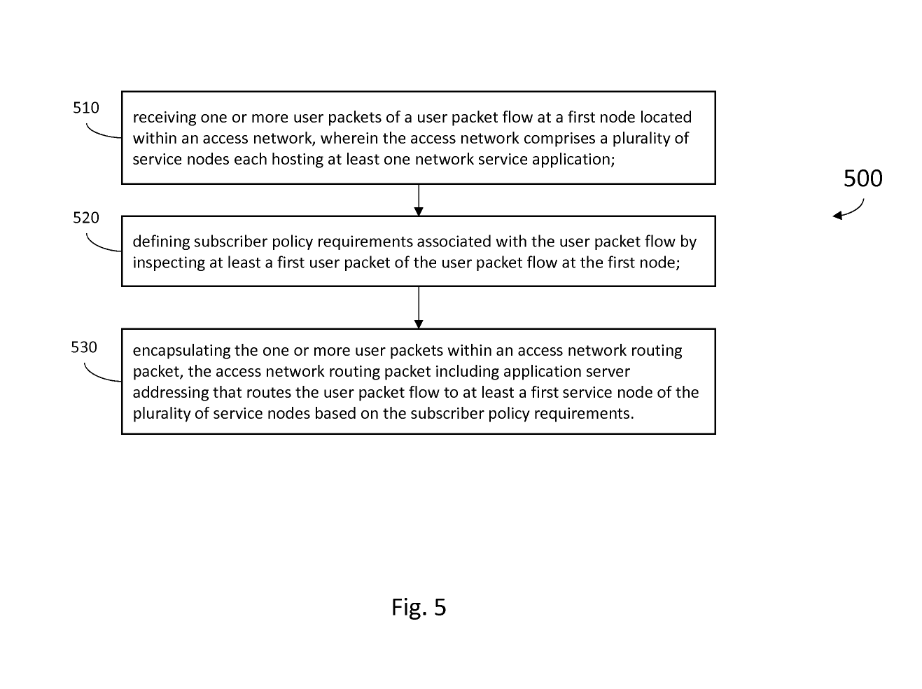

FIG. 5 is a flow chart illustrating a method 500 for providing network services within an access network. In alternate embodiments, method 500 can be implemented using any of the embodiments and their options and alternative described with respect to FIGS. 1-4 or combinations of parts thereof. Method 500 begins at 510 with receiving one or more user packets of a user packet flow at a first node located within an access network, wherein the access network comprises a plurality of network service nodes each hosting at least one network service application. For example, in one embodiment, the first node comprises an access node such as access node 125 described above. For some embodiments, the first node may comprise a combination access node plus switching device or a combination access node plus BNG. For alternate embodiment, the access network provides an access infrastructure that communicatively couples a local network to an IP network such as the public Internet, or a closed-access proprietary network IP network, or possibly access to both. A demarcation device may be provided between the first node and the local network. One or more content application servers external to the access network are made accessible to users of the local network through the access network's connection to the IP Network. The access network itself may operate as an OSI Layer 2 data link layer network. Example services which may be provided by content the application servers include, but are not limited to, television programming, email, Voice over IP (VoIP) telephone, video-on-demand services (such as but not limited to “Netflix”), social media services (such as, but not limited to “Facebook” and “Twitter”), and the like. The network service nodes comprise servers within the access network that host applications providing services offered by the CSP. Examples of potential services which can be offered through network service nodes are provided above. The network service nodes may be subtended directly from the first node, or from another access network device.

The method proceeds to 520 with defining subscriber policy requirements associated with the user packet flow by inspecting at least a first user packet of the user packet flow at the first node. That is, the first node comprises an enhanced access node which includes application awareness functionality on top of the functions typically provided by an access node. For example, the first node may performs deep packet inspection of the traffic flowing from and into the local network. By performing deep packet inspection, the first node is able to detect an interaction associated with a user packet and identify that packet as part of a certain user packet flow. Subscriber policy requirements which are to be applied to the user packet flow are then defined at least in part based on the information discovered through the deep packet inspection. In addition to information discovered by the first node, provisioned information, and dynamic information may also be used to the defined subscriber policy requirements for a user packet flow. The defined subscriber policy requirements for a user packet flow then establish which, if any, of the network services provided by the network service nodes are to be applied to the user packet flow. For example, in the same manner as described above, one set of user packet flows may be exposed to a parental control application, which another is exposed to a network security application. Using this information, the first node establishes a path through the access network that the user packet, and the relevant information collected by first node will take.

The method proceeds to 530 with encapsulating the one or more user packets within an access network routing packet, the access network routing packet including application server addressing that routes the user packet flow to at least a first service node of the plurality of service nodes based on the subscriber policy requirements. In one embodiment, the first node encapsulates the original user packets within a new packet referred to herein as an access network routing packet. FIG. 2 provides one example of an encapsulation structure 200 which may be used for an access network routing packet. However, it should be appreciated that not every access network routing packet needs to include every section illustrated in FIG. 2 and that the packet sections included in an access network routing packet may vary based on factors such as the network and subscriber policies being applied to a user packet, and the information needed to carry out those policies.

The methodology presented herein thus propos that the user flow packets are encapsulated into access network routing packets for ease of switching and routing within the access network and furthermore these access network routing packets are enhanced to include information that provisioned and potential services provided by the network service nodes can leverage. Examples of this information which may be provided within an access network routing packet and utilized by network service applications hosted on the network service nodes include: a subscriber identity and associated subscriber profile; a user identity and associated user profile; end user device identity and an associated profile; provisioned services and associated profiles; a client application identity; a content application identity; an assigned relative priority of the subscriber; and an assigned relative priority of the user packet flow.

### Example Embodiments

Example 1 includes a method for providing network services within an access network, the method comprising: receiving one or more user packets of a user packet flow at a first node located within an access network, wherein the access network comprises a plurality of service nodes each hosting at least one network service application; defining subscriber policy requirements associated with the user packet flow by inspecting at least a first user packet of the user packet flow at the first node; encapsulating the one or more user packets within an access network routing packet, the access network routing packet including application server addressing that routes the user packet flow to at least a first service node of the plurality of service nodes based on the subscriber policy requirements.

Example 2 includes the method of example 1, wherein the access network is further coupled to a local subscriber network by a demarcation device, the local subscriber network comprising one or more user devices.

Example 3 includes the method of example 2, wherein defining subscriber policy requirements associated with the user packet flow further comprises: determining a subscriber and a user device associated with the user packet flow by inspecting the at least a first user packet of the user packet flow at the first node.

Example 4 includes the method of example 3, wherein defining subscriber policy requirements associated with the user packet flow further comprises: associating a user identity with the user device.

Example 5 includes the method of any of examples 2-4, wherein defining subscriber policy requirements associated with the user packet flow further comprises: associating a content application service with the user packet flow, wherein the content application service is hosted by an application server accessible through one or both of an internet protocol (IP) network infrastructure or an Ethernet based network infrastructure.

Example 6 includes the method of any of examples 2-5, wherein the one or more user packets are inbound packets having a designation address within the local subscriber network.

Example 7 includes the method of any of examples 2-6, wherein the one or more user packets are outbound packets originating from the local subscriber network.

Example 8 includes the method of any of examples 1-7, wherein encapsulating the one or more user packets within the access network routing packet further comprises: providing an ordered list of application server addressing within the access network routing packet.

Example 9 includes the method of example 8, further comprising: directing the user packet flow to a first service node using a first application server address indicated in the ordered list of application server addressing; and applying the at least one network service application to the one or more user packets of the user packet flow.

Example 10 includes the method of example 9, further comprising: after applying the at least one network service application to the one or more user packets of the user packet flow, modifying the access network routing packet based on the ordered list of application server addressing; and directing the user packet flow to a second service node using a second application server addresses indicated in the ordered list of application server addressing.

Example 11 includes the method of any of examples 1-10, wherein the access network operates as an OSI Layer 2 data link layer network or an OSI Layer 3 network layer network.

Example 12 includes the method of any of examples 1-11, wherein the first node discovers a user identity associated with the user packet flow by extracting user information from a user packet flow between a user and an authentication service.

Example 13 includes an access network system, the system comprising: an access node coupled between a local subscriber network and an IP network, where the local subscriber network and the IP network are both external to the access network, the local subscriber network comprising one or more end-user devices, and the IP network being coupled to the access network through a broadband network gateway; a plurality of service nodes each hosting at least one network service application; wherein the access node inspects one or more user packets of a user packet flow within the access network, and wherein the access node identifies subscriber policy requirements associated with the user packet flow by inspecting at least a first user packet of the user packet flow; wherein the access node encapsulates the one or more user packets each within an access network routing packet, the access network routing packet including application server addressing that routes the user packet flow through the access network to at least a first service node of the plurality of service nodes based on the subscriber policy requirements.

Example 14 includes the system of example 13, wherein the one or more user packets are inbound packets having a designation address within the local subscriber network.

Example 15 includes the system of any of examples 13-14, wherein the one or more user packets are outbound packets originating from the local subscriber network.

Example 16 includes the system of any of examples 13-15, wherein the access node defines subscriber policy requirements associated with the user packet flow by determining a subscriber and a user device associated with the user packet flow by inspecting the at least a first user packet of the user packet flow at the first node.

Example 17 includes the system of example 16, wherein the access node defines subscriber policy requirements associated with the user packet flow by associating a user identity with the user device.

Example 18 includes the system of any of examples 16-17, wherein the access node defines subscriber policy requirements associated with the user packet flow by associating a content application service with the user packet flow, wherein the content application service is hosted by an application server accessible through an internet protocol (IP) network that is coupled to the access network via a broadband network gateway.

Example 19 includes the system of any of examples 13-18, wherein the access node includes within the access network routing packet an ordered list of application server addressing within the access network routing packet.

Example 20 includes the system of any of examples 13-19, wherein the access network operates as an OSI Layer 2 data link layer network or an OSI Layer 3 network layer network.

Example 21 includes the system of any of examples 13-20, wherein the access node discovers a user identity associated with the user packet flow by extracting user information from a user packet flow between a user and an authentication service.

In various alternative embodiments, any of the systems or methods described throughout this disclosure may be implemented on systems comprising a processor executing code to realize the applications, nodes, functions and other elements described with respect to the above described embodiments, said code stored on a non-transient data storage device. Therefore other embodiments of the present disclosure include program instructions resident on computer readable media which when implemented by such systems, enable them to implement the embodiments described herein. As used herein, the term “computer readable media” refers to tangible memory storage devices having non-transient physical forms. Such non-transient physical forms may include computer memory devices, such as but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device having a physical, tangible form. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for providing network services within an access network, the method comprising:
receiving one or more user packets of a user packet flow at a first node located within an access network, wherein the access network comprises a plurality of service nodes each hosting at least one network service application;
defining subscriber policy requirements associated with the user packet flow by inspecting at least a first user packet of the user packet flow at the first node; and
encapsulating the one or more user packets within an access network routing packet, the access network routing packet including application server addressing that routes the user packet flow to at least a first service node of the plurality of service nodes based on the subscriber policy requirements.

2. The method of claim 1, wherein the access network is further coupled to a local subscriber network by a demarcation device, the local subscriber network comprising one or more user devices.

3. The method of claim 2, wherein defining subscriber policy requirements associated with the user packet flow further comprises:
determining a subscriber and a user device associated with the user packet flow by inspecting the at least a first user packet of the user packet flow at the first node.

4. The method of claim 3, wherein defining subscriber policy requirements associated with the user packet flow further comprises:
associating a user identity with the user device.

5. The method of claim 2, wherein defining subscriber policy requirements associated with the user packet flow further comprises:
associating a content application service with the user packet flow, wherein the content application service is hosted by an application server accessible through one or both of an internet protocol (IP) network infrastructure or an Ethernet based network infrastructure.

6. The method of claim 2, wherein the one or more user packets are inbound packets having a designation address within the local subscriber network.

7. The method of claim 2, wherein the one or more user packets are outbound packets originating from the local subscriber network.

8. The method of claim 1, wherein encapsulating the one or more user packets within the access network routing packet further comprises:
providing an ordered list of application server addressing within the access network routing packet.

9. The method of claim 8, further comprising:
directing the user packet flow to a first service node using a first application server address indicated in the ordered list of application server addressing; and
applying the at least one network service application to the one or more user packets of the user packet flow.

10. The method of claim 9, further comprising:
after applying the at least one network service application to the one or more user packets of the user packet flow, modifying the access network routing packet based on the ordered list of application server addressing; and
directing the user packet flow to a second service node using a second application server addresses indicated in the ordered list of application server addressing.

11. The method of claim 1, wherein the access network operates as an OSI Layer 2 data link layer network or an OSI Layer 3 network layer network.

12. The method of claim 1, wherein the first node discovers a user identity associated with the user packet flow by extracting user information from a user packet flow between a user and an authentication service.

13. An access network system, the system comprising:
an access node coupled between a local subscriber network and an IP network, where the local subscriber network and the IP network are both external to the access network, the local subscriber network comprising one or more end-user devices, and the IP network being coupled to the access network through a broadband network gateway; and
a plurality of service nodes each hosting at least one network service application;
wherein the access node inspects one or more user packets of a user packet flow within the access network, and wherein the access node identifies subscriber policy requirements associated with the user packet flow by inspecting at least a first user packet of the user packet flow;
wherein the access node encapsulates the one or more user packets each within an access network routing packet, the access network routing packet including application server addressing that routes the user packet flow through the access network to at least a first service node of the plurality of service nodes based on the subscriber policy requirements.

14. The system of claim 13, wherein the one or more user packets are inbound packets having a designation address within the local subscriber network.

15. The system of claim 13, wherein the one or more user packets are outbound packets originating from the local subscriber network.

16. The system of claim 13, wherein the access node defines subscriber policy requirements associated with the user packet flow by determining a subscriber and a user device associated with the user packet flow by inspecting the at least a first user packet of the user packet flow at the first node.

17. The system of claim 16, wherein the access node defines subscriber policy requirements associated with the user packet flow by associating a user identity with the user device.

18. The system of claim 16, wherein the access node defines subscriber policy requirements associated with the user packet flow by associating a content application service with the user packet flow, wherein the content application service is hosted by an application server accessible through an internet protocol (IP) network that is coupled to the access network via a broadband network gateway.

19. The system of claim 13, wherein the access node includes within the access network routing packet an ordered list of application server addressing within the access network routing packet.

20. The system of claim 13, wherein the access network operates as an OSI Layer 2 data link layer network or an OSI Layer 3 network layer network.

21. The system of claim 13, wherein the access node discovers a user identity associated with the user packet flow by extracting user information from a user packet flow between a user and an authentication service.
